(19) United States
(12) Patent Application Publication
(10) Pub. No.: US 2006/0277889 A1
(43) Pub. Date: Dec. 14, 2006

(54) Wind screen hold down attachment

(76) Inventors: Ronald Leo Sheedy, Eldridge, IA (US); Sheldon Joseph Grywacheski, Eldridge, IA (US); Jobey Matthew Schnepf, Davenport, IA (US)

Correspondence Address: DEERE & COMPANY, ONE JOHN DEERE PLACE, MOLINE, IL, 61265, US

(21) Appl. No.: 11/149,763

(22) Filed: Jun. 10, 2005

(51) Int. Cl. A01D 89/00

(52) U.S. Cl. 56/364

(57) ABSTRACT

A hold down mechanism controlling the top mat of crop material on a pickup belt platform includes a pair of support arms pivotally mounted on the opposite sides of the frame and extending longitudinally parallel to the rotatable pickup belt. A transverse cross member extends between the two support arms. The cross member has a tubular cross section and a transverse array of through holes, each through hole having a first opening and a diametrically opposite second opening in the tubular cross member, wherein the first opening is larger than the second opening. A plurality of hold down fingers are provided. Each finger has a flexible rod portion extending from and secured in a base portion. The base portion has a shoulder opposite the secured rod portion and a retaining portion extending from the shoulder opposite to the rod portion. A plurality of releasable retainers are provided. The base portions are inserted and mounted in the first openings in the tubular cross member so that the retaining portions extend through the second opening and are releasably secured adjacent the second openings by the retainers.

### FIELD OF THE INVENTION

This invention relates to a belt pickup mechanism for a combine harvester that has a hold down mechanism for controlling the mat of crop material when the crop material is lifted from the ground and is being moved rearward on the pickup belt to an auger, and more particularly to the windrow hold down fingers.

### BACKGROUND OF THE INVENTION

A combine harvester usually includes a transverse harvesting platform with a crop converging auger. When the combine harvests a standing crop, the harvesting platform is provided with cutting knives along the leading edge for cutting the crop material from the field. However, for certain crops and in certain geographic areas, the standing crop is first cut and allowed to dry in the field. The crop is laid in windrows by a windrowing machine. Later, a combine equipped with a pickup attachment raises the windrow of crop material from the ground as the combine advances. The pickup attachment feeds the crop rearward to the crop converging auger on the pickup platform. The pickup platform often uses a flexible pickup belt having a large number of outwardly extending pickup fingers or tines that engage the crop material and lift it from the ground. The crop material is conveyed to the rear on the upper run of the belt to the platform auger.

A windrow hold down or wind screen mechanism is positioned above the pickup belt to hold the mat of crop material down on the upper run of the belt so that it does not bunch up on the top of the belt in front of the auger. For best performance, the crop material is fed under the front side of the auger in a mat of fairly consistent thickness. A windrow hold down device includes a plurality of longitudinally extending flexible hold down rods that are mounted on and extend rearward in a cantilever manner from a transverse bar above the upper run of the pickup belt. The hold down rods normally engage the top of the mat of the crop material moving rearward along the upper run of the belt and prevent the formation of bunches of crop material on the top of the belt. The flexibility of the hold down rods allows for some variation in the thickness of the mat of crop material. However, there is a wide variation in crop conditions and the amount of crop material lying in a windrow. An adjustment mechanism is provided to adjust the clearance between the hold down rods and the top of the belt since the thickness of the windrows can vary due to crop conditions.

The hold-down rods are generally mounted on a bar attached to the opposite sides of the pickup mechanism frame. The flexible rods are free to flex vertically to accommodate some variation in the thickness of the mat of crop material. Currently it is necessary to use a multitude of parts, such as clamps, nuts and bolts and other hardware, to secure the round flexible rods on the generally flat transverse bars. Alternatively, the flexible rods have been constructed in complex shapes, such as an integral U-shaped twin rod member, to facilitate the rods being secured to the transverse bar.

The multitude of parts or the complex shapes make removal and replacement of broken hold down rods difficult when operating the pickup platform in the field. Thus, there is a need for a flexible hold down rod that has a straightforward construction and that is ease to replace in the field.

### SUMMARY OF THE INVENTION

An improved windrow hold down mechanism having replaceable flexible hold down fingers is provided for a belt type windrow pickup mechanism.

A mounting mechanism for the hold down fingers of a crop pickup platform allows easy and quick replacement of the hold down fingers when they broke in the field during harvesting. Additionally, the mounting for the hold down fingers requires minimal parts and provides a secure anchor.

A hold down mechanism controlling the top mat of crop material on a pickup belt platform includes a pair of support arms pivotally mounted on the opposite sides of the frame and extending longitudinally parallel to the rotatable pickup belt. A transverse cross member extends between the two support arms. The cross member has a tubular cross section and a transverse array of through holes, each through hole having a first opening and a diametrically opposite second opening in the tubular cross member, wherein the first opening is larger than the second opening. A plurality of hold down fingers are provided. Each finger has a flexible rod portion extending from and secured in a base portion. The base portion has a shoulder opposite the secured rod portion and a retaining portion extending from the shoulder opposite to the rod portion. A plurality of releasable retainers are provided. The base portions are inserted and mounted in the first openings in the tubular cross member so that the retaining portions extend through the second opening and are releasably secured adjacent the second openings by the retainers.

### BRIEF DESCRIPTION OF THE DRAWINGS

FIG. 1 is a schematic view of a pickup platform for a combine harvester showing a hold down mechanism mounted above the pickup belt;

FIG. 2 is a perspective view, partially exploded, of the hold down mechanism; and

FIG. 3A is a side sectional view of a tubular cross member and a hold down finger along line 3-3 of FIG. 2.

FIGS. 3B and 3C show alternative embodiments for retaining the hold down fingers in the cross member.

### DETAILED DESCRIPTION OF THE INVENTION

A windrow pickup platform 10 is carried on the front of a combine and includes a frame 12 supported primarily by the combine. The frame is also partially supported by gauge wheels 14 at the front of the platform. The gauge wheels roll along the ground when the machine is being operated. On uneven terrain, the gauge wheels support the platform according to the contour of the ground.

A transversely extending platform auger 16 extends between the opposite sides of the pickup platform frame. The auger converges crop material that is delivered to the platform and discharges it rearward through a discharge opening which registers with an opening in the feeder house of the combine (not shown).

The windrow pickup platform 10 also includes multiple rollers 20 transversely extending between the opposite sides of the frame. At least one endless belt is looped around the rollers. Preferably two belts are used, including a forward pickup belt 22 and a rear transport belt 24. The belts are each looped around two rollers. The endless belts are conventionally formed by slicing belt sections. The pickup belt 22 includes a large number of outwardly extending pickup fingers 26 that sweep close to the ground at the forward end of the pickup mechanism to engage windrowed crop material lying on the ground. The crop material is picked up and conveyed to the rear by the pickup fingers on the rearward moving upper run of the pickup belt. If the platform includes a second belt, the crop material is then deposited on the transport belt 24. In either configuration, the rearmost roller 20 of the pickup mechanism (either the pickup belt or the transport belt) is positioned in front of the lower portion of the auger. Thus, the crop material is discharged immediately in front of the auger 16.

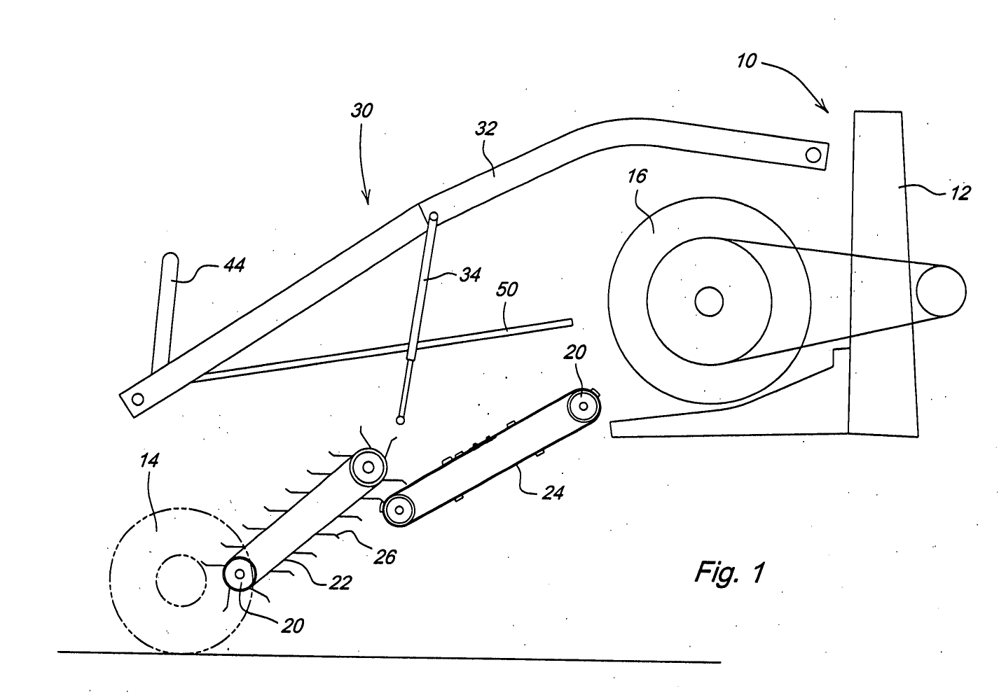

A windrow hold down mechanism 30 transversely spans the width of the crop pickup platform above the belt or belts and generally in front of the auger. The windrow hold down mechanism includes a pair of support arms 32 that are pivotally supported by the frame. As seen in FIG. 1, the support arms 32 are parallel and extend generally longitudinally in the opposite direction of travel of the lifted crop. The height of the support arms is adjusted by an adjusting device such as a hydraulic cylinder 34.

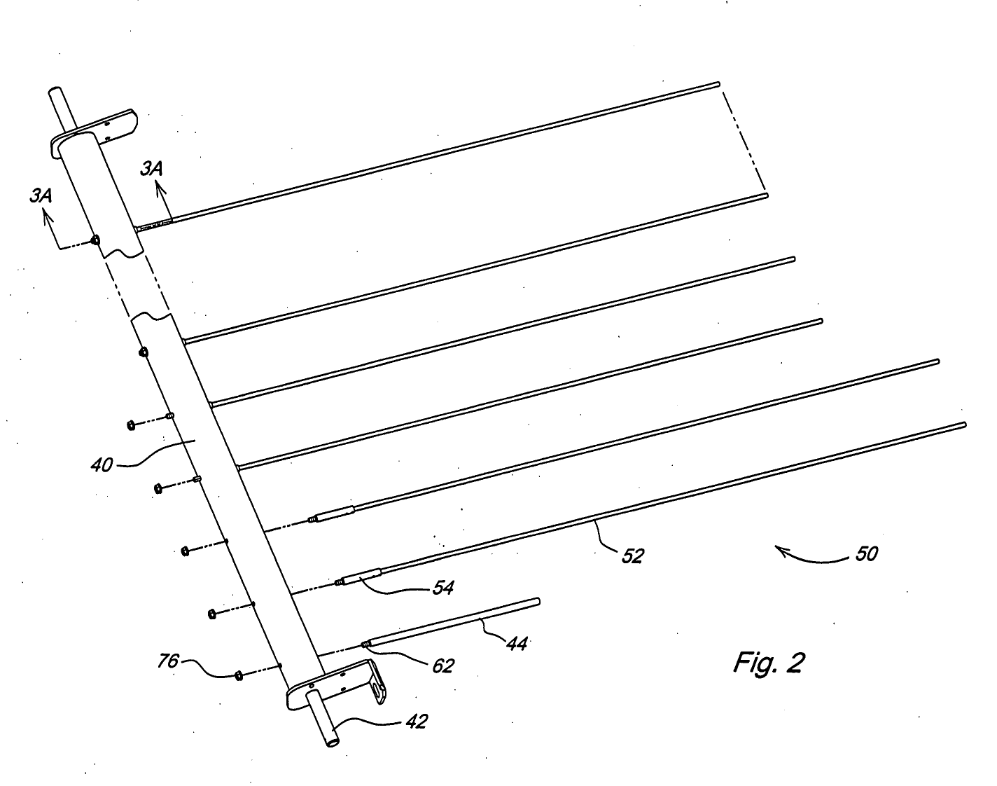

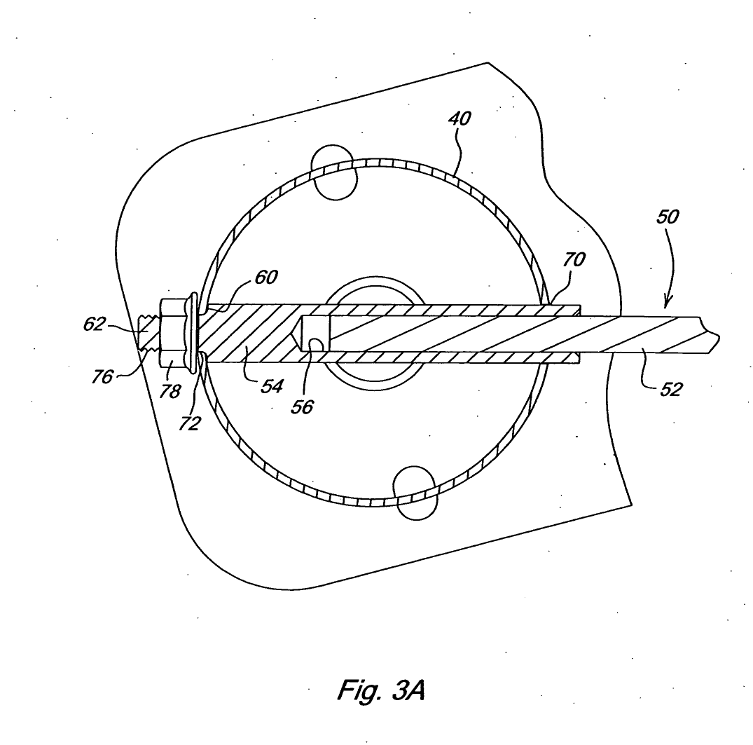

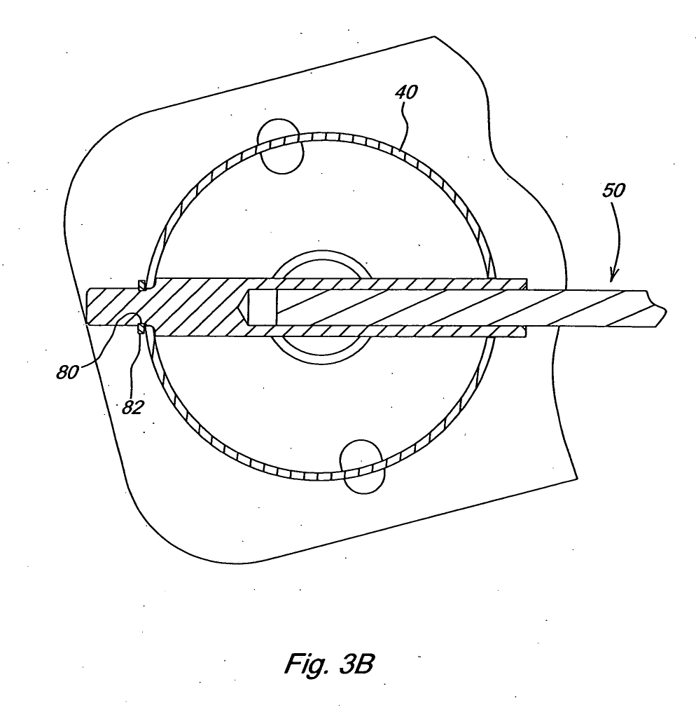

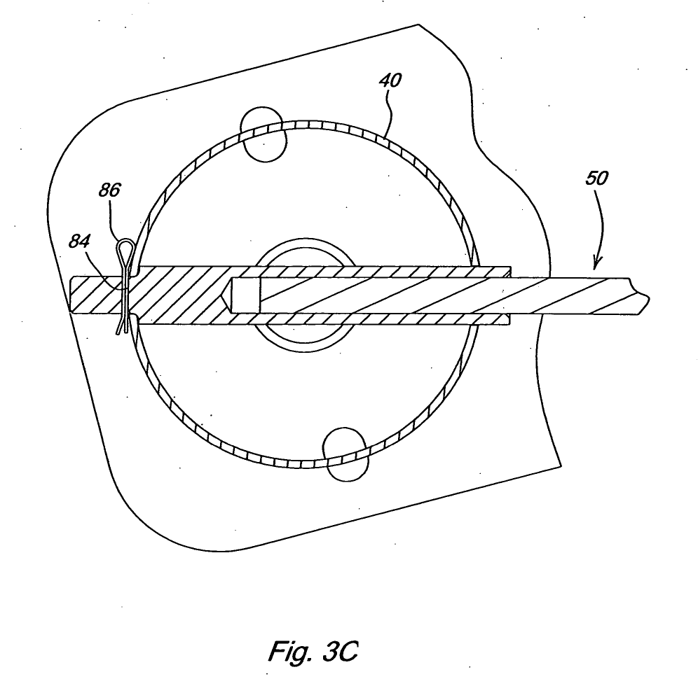

As shown in FIGS. 2 and 3, a transverse cross member 40 extends between the forward ends of the support arms 32. The cross member is preferably tubular in cross section. The opposite ends of the cross member 40 are pivotally connected to the respective support arms by pivot shafts 42. A lever 44 allows the support arms to be manually tilted about the pivot shafts depending on the height and condition of the windrow crop.

A plurality of hold down fingers 50 are mounted on the transverse cross member 40 and extend generally rearward from the cross member 40 toward the auger 16. The hold down fingers include a flexible portion formed by elongated flexible rods 52, such as fiberglass rods. One end of the flexible rods are secured or permanently mounted in a base portion 54. The base portion is generally cylindrical and has an outer diameter that is larger than the diameter of the flexible rod. The base portion may be constructed as an aluminum or plastic cylinder and has an axial bore 56 for receiving one end of the flexible rod. The flexible rods 52 are swaged, molded, glued, force fit or otherwise secured in the axial bore 56.

A shoulder 60 at the rear of the base portion 54 defines a smaller diameter retaining portion 62. The retaining portion 62 is also generally cylindrical and has a smaller diameter than the diameter of the base portion 54. The retaining portion extends axially from the shoulder 60 of the base portion in the direction opposite to the flexible rods 52.

A plurality of through holes 66 are provided in the cross member 40. Each through hole preferably extends diametrically across the diameter of the tubular cross member 40, that is, the through holes intersect the longitudinal axis of the tubular cross member. The through holes define first and second openings in the tubular cross member. The first opening 70 in the tubular cross member has a predetermined diameter that is larger than the predetermined diameter of the second opening 72.

As seen in FIG. 3A, the base portion 54 of the hold down fingers 50 is inserted through the first opening 70 in the tubular cross member 40 until the shoulder 60 of the base portion abuts the inside surface of the tubular cross member at the second smaller opening 72. The retaining portion 62 of the base portion extends through the second opening in the tubular cross member. Releasable retainers, which will presently be described, secure the retaining portion 62 at the outside surface of the tubular cross member adjacent the second smaller diameter hole 72.

The retaining portion 62 is generally cylindrical and extends axially from the base portion 54. Preferably, as shown in FIG. 3A, the retaining portion is threaded 76 and the retainer member is a locking nut 78. The locking nut is tightened on the threaded end of the retaining portion to secure the shoulder 60 of the base portion against the inside surface of the tubular cross member 40.

Alternatively, as shown in FIG. 3B, the cylindrical retaining portion 62 can be configured to have a circumferential groove 80 and the releasable retaining member can be a snap ring 82. The snap ring snaps into the groove to secure the extending retaining portion 62. In another alternative, shown in FIG. 3C, the cylindrical retaining portion 62 can be configured to have a cross bore 84 and the releasable retaining member can be a cotter pin 86 or a similar insertable member.

Thus, the flexible hold down fingers 50 can be easily replaced on the cross member 40 by simply removing the releasable retainer and withdrawing the base portion 54 of the hold down fingers from the through holes of the tubular cross member 40.

A mechanical stop limits the rotation of the tubular cross member 40 and hold down fingers on the support arms 32. However, the flexible hold down fingers 50 can still flex upwardly to accommodate mats of crop material that are thicker than the clearance between the belt or belts and the extending ends of the hold down fingers 50. The weight of the hold down mechanism 30 holds the support arms 32 against the stops to establish the lowermost position of the hold down fingers. The pivotal connection of the tubular cross member 50 to the support arms 32 permits the hold down fingers to be swung upward and forward for access to the top of the pickup mechanism.

Angular adjustment of the cross member 40 relative to the support arms 32 permits adjustment of the clearance between the ends of the hold down fingers 50 and the upper run of the belts. Adjustment of the support arms allows adjustment of the distance between the rearward ends of the hold down fingers 50 and the auger 16. Also, as previously described, the hold down fingers are swingable upward from their lowermost position on the stops to accommodate a greater thickness of the mat of crop material moving through the pickup platform and into the harvesting machine.

1. A hold down mechanism for a crop pickup platform, the platform having a frame supporting at least one longitudinally rotatable pickup belt and a transverse platform auger, the pickup belt transversely extending between opposite sides of the frame and rotatable to lift crop material from the ground and conveying the lifted crop material to the platform auger, the hold down mechanism controlling the top mat of crop material on the pickup belt and comprising:
a pair of support arms pivotally mounted on the opposite sides of the frame and extending longitudinally parallel to the rotatable pickup belt;
a transverse cross member extending between the two support arms, the cross member having a tubular cross section and having a transverse array of through holes, each through hole having a first opening and a diametrically opposite second opening in the tubular cross member, wherein the first opening is larger than the second opening;
a plurality of hold down fingers, each finger having a flexible rod portion extending from and secured in a base portion, the base portion having a shoulder opposite the secured rod portion and a retaining portion extending from the shoulder opposite to the rod portion; and
a plurality of releasable retainers, wherein the base portions are inserted and mounted in the first openings in the tubular cross member so that the retaining portions extend through the second opening and are releasably secured adjacent the second openings by the retainers.

2. The hold down mechanism of claim 1 wherein the flexible rod portions are cantilevered above the pickup belt.

3. The hold down mechanism of claim 1 wherein the retaining portion is threaded and the releasable retainer is a locking nut.

4. The hold down mechanism of claim 1 wherein the retaining portion has a circumferential groove and the releasable retainer is a snap ring.

5. The hold down mechanism of claim 1 wherein the retaining portion has a cross bore and the releasable retainer is a cotter pin.

6. The hold down mechanism claim 1 wherein cross member includes adjustment means operative to position the hold down fingers at different angles.
